(19) United States
(12) Patent Application Publication
(10) Pub. No.: US 2026/0301046 A1
(43) Pub. Date: Oct. 1, 2026

(54) METHOD FOR SMART FASHION COORDINATION SERVICE

(71) Applicant: IFU INTERNATIONAL INC, Seoul (KR)

(72) Inventor: Miyoung CHA, Seoul (KR)

(73) Assignee: IFU INTERNATIONAL INC, Seoul (KR)

(21) Appl. No.: 19/478,654

(22) PCT Filed: Apr. 27, 2023
(86) PCT No.: PCT/KR2023/005762

§ 371 Date: Oct. 24, 2025

(51) Int. Cl. G06Q 30/0601; G06T 7/62

(52) U.S. Cl. CPC G06Q 30/0631; G06Q 30/06212; G06Q 30/06432; G06T 7/62; G06T 2207/30196

(57) ABSTRACT

The present invention relates to a smart fashion coordination service method that photographs a user's body using a mobile application (from various angles and/or as a video), measures body dimensions from the captured body images, performs two-dimensional photography of clothing placed on a flat surface, extracts clothing measurements and body proportion information from the captured clothing images, compares and analyzes the body information and clothing information to determine whether the coordination is appropriate or inappropriate, and recommends ready-made garments for coordination determined to be appropriate or proposes golden ratio lines for custom-made clothing when the coordination is determined to be inappropriate.

### TECHNICAL FIELD

The present invention relates to a smart fashion coordination service method that enables selection of clothing suitable for a user's body measurements, body shape, and image using photographs taken through a mobile application without requiring fitting, and allows coordination of clothing that is suitable for the user's body shape and provides a body-shaping effect.

### BACKGROUND ART

The ratio of head length to height is called the head-to-body ratio, which refers to how many times the height measures compared to the head length when the head size is set to 1. Although height varies among individuals, both men and women generally share similar proportions, averaging about seven to seven and a half heads in height. Along with height and the head-to-body ratio, the proportion between the upper and lower body is also an important factor in fashion styling.

The proportions among body parts also differ from person to person, and clothing can be used to highlight advantages and conceal shortcomings. Body shape is an inherent physical characteristic that cannot be easily changed, so methods of creating visual changes through clothing have recently gained importance. Even if a design is fashionable, it may not suit a particular body type or may appear unnatural when worn. Therefore, individuals tend to seek styles that complement their body shape and are increasingly placing emphasis on achieving a harmonious silhouette.

However, many consumers are unaware of their exact size when purchasing clothing, and online shopping requires considerable time and effort to find the most suitable product from among a wide range of products. Accordingly, curation services that recommend only the most relevant items for each individual are attracting increasing attention.

Even in offline shopping, there is the inconvenience of having to try on each garment, while in online shopping, it is difficult to determine whether an item truly suits the wearer, and the process of returning unsuitable items is also cumbersome

The increase in product returns has become a major burden for online retailers, as the number of returned items continues to rise along with sales growth. As a strategy to reduce returns, some retailers operate programs that display measurement information to consumers based on their previous purchase records. Although they strive to provide consumers with the most suitable sizes by extensively analyzing product data, including size and fit, along with consumer-related information, return rates have shown little improvement.

Furthermore, sellers are making various efforts to minimize returns, even going so far as to store consumers' inquiries to develop artificial intelligence-based “shopping advisor” programs.

### SUMMARY OF INVENTION

### Problems to be Solved by Invention

An object of the present invention is to provide a fashion coordination service method that allows users to purchase and coordinate clothing suitable for them anytime and anywhere. In addition, the invention aims to provide a smart fashion coordination service method that simply and accurately identifies a consumer's body measurements and body type, matches these measurements with clothing dimensions, and provides harmonious fashion coordination, all without the need for professional assistance.

Furthermore, another object of the present invention is to provide a smart fashion coordination service method that fundamentally differs from conventional virtual simulation CAD systems, which measure the body using 3D measuring devices to create avatars and perform virtual try-ons, or from body type-specific coordination systems based on classification of body types.

Moreover, still another object of the present invention is to provide a smart fashion coordination service method that enables 1:1 personalized coordination by analyzing an individual's body proportions and matching them to clothing proportions, rather than relying on virtual fitting simulations or body type-based coordination. The present invention also aims to provide a smart fashion coordination service method that accurately measures the user's body, calculates proportional ratios, identifies physical strengths and weaknesses, and suggests a personalized golden ratio for clothing coordination.

### Means for Solving Problems

In order to achieve the above-described object, the present invention provides a smart fashion coordination service method including: photographing, by the mobile terminal, a body of a user with a camera of the mobile terminal to capture a body image; transmitting, by the mobile terminal, the captured body image to a server; measuring, by the server, the user's body measurements from the received body image to obtain body measurement information; photographing, by the mobile terminal, clothing owned by the user with the camera of the mobile terminal to capture a clothing image; transmitting, by the mobile terminal, the captured clothing image to the server; measuring, by the server, the clothing measurements and body proportions from the received clothing image to obtain clothing measurement information and body proportion information; determining, by the server, whether coordination is appropriate or inappropriate based on preset criteria by matching the user's body measurement information with the clothing measurement information and body proportion information; providing, by the server, ready-made garment product information included in a product line composed of multiple ready-made garments to the mobile terminal of the user for whom the coordination is determined to be appropriate; and providing, by the server, custom-made clothing product information corresponding to the user's body measurement information to the mobile terminal of the user for whom the coordination is determined to be inappropriate.

In addition, the step of photographing, by the mobile terminal, a body of a user with a camera of the mobile terminal to capture a body image, and the step of photographing, by the mobile terminal, clothing owned by the user with the camera of the mobile terminal to capture a clothing image may be performed together with a size measuring member disposed adjacent to the user's body and/or the clothing, the size measuring member being made of a standard product.

In one embodiment, the size measuring member may be an A4 paper.

In one embodiment, the size measuring member may be a scale background board having scales arranged at regular intervals and extending in at least one direction.

In addition, the method may further include inputting, into the mobile terminal, matching condition information such as the user's taste, preferred style, and coordination suitable for a given time, place, and occasion (TPO); and
transmitting, by the mobile terminal, the matching condition information to the server, wherein, in the step of providing, by the server, ready-made garment product information included in a product line composed of multiple ready-made garments to the mobile terminal of the user for whom the coordination is determined to be appropriate, and in the step of providing, by the server, custom-made clothing product information corresponding to the user's body measurement information to the mobile terminal of the user for whom the coordination is determined to be inappropriate, ready-made garment product information or custom-made clothing product information filtered based on the matching condition information received from the mobile terminal may be provided.

Further, the step of photographing, by the mobile terminal, a body of a user with a camera of the mobile terminal to capture a body image may include obtaining multiple body images taken from two or more different photographing distances and/or photographing angles.

Furthermore, the method may further include adjusting, by the server, sizes of the received body images and/or clothing images based on a captured image size of a size measuring member included in the received body images and/or clothing images.

Furthermore, the step of measuring, by the server, the clothing measurements and body proportions from the received clothing image to obtain clothing measurement information and body proportion information may include acquiring clothing measurement information and body proportion information from the location, size, or number of one or more of the following groups included in the received clothing image: cut lines (horizontal and vertical), buttons, pockets, straps, epaulets, tapes, lace decorations, and belt loops.

Furthermore, the method may further include matching pre-captured dimensional information of a subject obtained through photographing with actual measured dimensional information, and performing regression analysis on correlations therebetween to derive and pre-store a calculation formula for determining body measurement information, wherein the step of measuring, by the server, the user's body measurements from the received body image to obtain body measurement information may include obtaining the body measurement information using the calculation formula pre-stored in the server.

In addition, the server may pre-set and store a body type classification code for classifying measured body measurement information according to preset criteria, and may generate a body type classification code for the user by substituting ratios of the user's measured body dimensions as variables into the preset classification criteria.

Furthermore, the server may pre-set and store a suitable body type code for classifying extracted clothing measurement information and body proportion information according to preset criteria, and may generate a suitable body type code for the corresponding clothing by substituting extracted clothing measurement information and body proportion information as variables into the preset classification criteria.

### Advantageous Effects

According to embodiments of the present invention, clothing consumers may save time and effort when purchasing clothing, thereby reducing the likelihood of failure in online clothing selection and minimizing economic losses. Manufacturers can predict demand based on a consumer database, enabling accurate planning and production, which in turn increases net profits. Sellers may also experience increased sales due to reduced returns and lower inventory burdens. Furthermore, consumer matching among small and medium-sized enterprises will be activated, contributing to the stabilization of the fashion industry through reduced risks and increased sales.

### BRIEF DESCRIPTION OF DRAWINGS

FIG. 1 is a view illustrating the concept of a smart fashion coordination service method according to an embodiment of the present invention.

FIG. 2 is a view illustrating examples of photographing poses provided for a body measurement service according to an embodiment of the present invention.

FIG. 3 is a view illustrating a scale background board and a foot board used in photography.

FIG. 4 is a view illustrating the actual measured regions of a subject and the corresponding measurement regions on a photograph according to the present invention.

FIG. 5 is a view illustrating the angles of respective body parts measured on the actual body of a subject and the corresponding angles measured on a photograph according to the present invention.

FIG. 6 is a view illustrating an example of the golden ratio line according to an embodiment of the present invention.

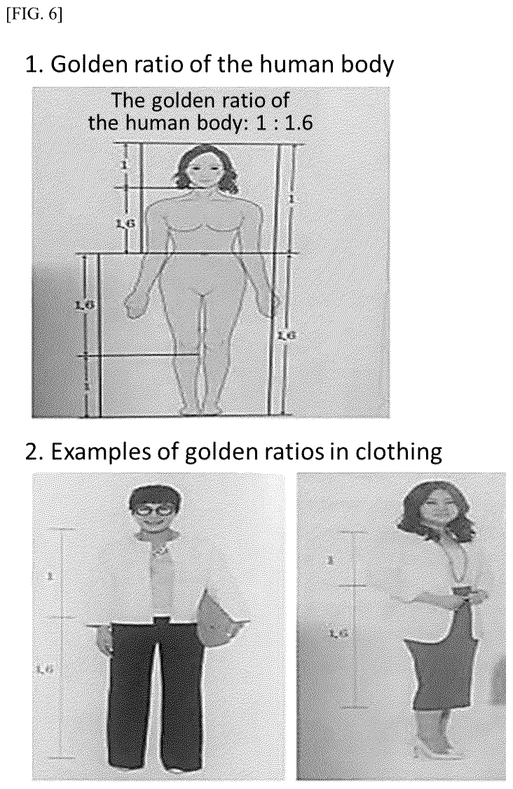

FIG. 7 is a view illustrating an example of body measurement according to an embodiment of the present invention.

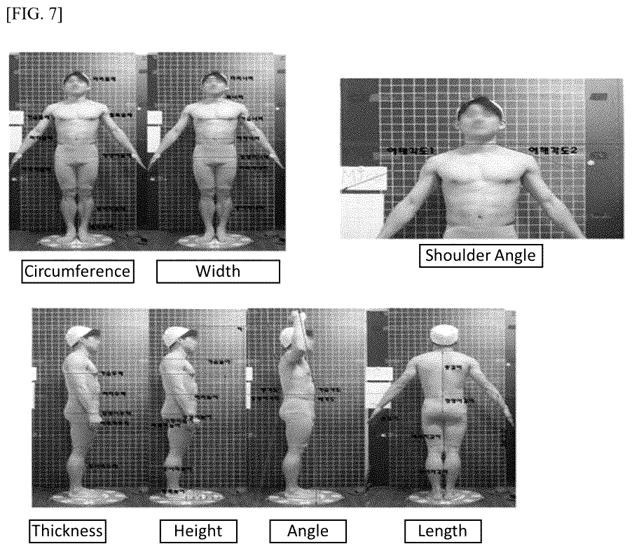

### MODE FOR CARRYING OUT INVENTION

Hereinafter, embodiments of the present invention will be described in detail with reference to the accompanying drawings so that those skilled in the art to which the invention pertains may easily carry out the invention.

The overall process of a smart fashion coordination service method according to an embodiment of the present invention is as follows. The present invention relates to a service provided by an application installed on a mobile terminal, typically a smartphone, which communicates with a server.
1. A user's body is photographed (from various angles and/or as a video) using an application (app) installed on the mobile terminal, and the captured body images are transmitted to the server.
2. The server measures body dimensions from the captured body images to obtain body measurement information. In this process, the server calculates the proportions of each body element, including circumference, width, thickness, length, angle, and height, identifies the user's strengths and weaknesses, and highlights strengths while concealing weaknesses based on the calculated proportions of each body element, including circumference, width, thickness, length, angle, and height.
2-1. The server calculates the ratios of the measured body dimensions and generates a body type classification code (including a body type strength code and a body type weakness code) for the user based on preset criteria. In this case, the body type classification code, the body type strength code, and the body type weakness code are preset and stored in the server together with corresponding classification criteria, and the body type classification code may be derived by substituting the ratios of the user's measured body dimensions as variables into the preset classification criteria.
3. The user places clothing on a flat surface, photographs it with a mobile terminal, and the mobile terminal transmits the captured clothing images to the server.
4. The server extracts clothing measurement information and body proportion information from the received clothing images. In this process, the server measures the garment's total length, back length, sleeve length, width, horizontal and vertical lines, and body-fit proportions.
4-1. The server calculates the clothing measurement information and body proportion information extracted from the clothing images and automatically generates a suitable body type code (including a suitable clothing strength code and a suitable clothing weakness code) for the garment based on preset criteria. In this case, the suitable body type code, the suitable clothing strength code, and the suitable clothing weakness code are preset and stored in the server together with corresponding classification criteria, and the suitable body type code may be derived by substituting the ratios of the user's measured body dimensions as variables into the preset classification criteria.
5. The server matches the body measurement information with the clothing measurement information, compares and analyzes the matched data, and determines whether the coordination is appropriate or inappropriate.
6. The server recommends ready-made garments for coordination determined to be appropriate, and recommends custom-made clothing for coordination determined to be inappropriate.
7. When the server matches the body measurement information with the clothing measurement information, matching variables may further include color, pattern size, and pattern arrangement.
8. Furthermore, the matching variables may also include factors reflecting the user's taste, preferred style, and coordination suitable for a given time, place, and occasion (TPO).
9. By numerically coding and statistically analyzing various types of information, including the matching variables, a matching suitability rate between body items and clothing items may be provided.
10. When the matching suitability rate is high, ready-made garment is recommended, whereas when the rate is low, custom-made clothing is recommended. This enables easy customization of ready-made garment to fit the user's body type, as well as the production of custom-made clothing optimized for the user's unique body shape.
10-1. Furthermore, it becomes possible to specifically propose the dimensions of a custom-made clothing pattern.

Here, the matching variables within the body measurement information may include a head-to-body ratio (the ratio of head size to body size), a height ratio (the ratio between the upper body and lower body), a width ratio (the ratio of body width in the front and back views), a thickness ratio (the ratio of body thickness in the side view), a length ratio (the ratio of limb length such as arms and legs), and a silhouette (body silhouette information according to the width ratio).

Meanwhile, the matching variables within the clothing measurement information may include a garment length ratio (the ratio of body position when worn to the total garment length), a fit ratio of garment width (the body circumference fit ratio when worn), a sleeve and trouser length ratio (the fit ratio of sleeve and pant lengths), a detail size ratio (the ratio indicating the suitability of detail size relative to the body type), a line ratio (horizontal line ratio producing an optical effect of elongating the lower body, vertical line ratio producing an optical effect of a slimmer appearance, as well as seam lines, dart lines, functional lines, construction lines, design lines, detail lines, and decorative lines), a pattern and motif ratio (the wearing or visual ratio determined by the size and arrangement of patterns and motifs), a material property suitability (the wearing suitability according to the physical properties of the material), and color matching (matching colors suitable for the user's skin or face tone).

Meanwhile, when identifying the variables for the detail size ratio, the body position may be determined based on the location, size, and number of buttons, while the position and size of details such as pockets, buckles, epaulettes, and belt loops may be used to identify the corresponding body parts and shapes.

Once the body type classification code is generated by combining the body type strength code and the body type weakness code, it becomes possible to match it with a suitable body type code generated by combining the clothing strength code and the clothing weakness code.

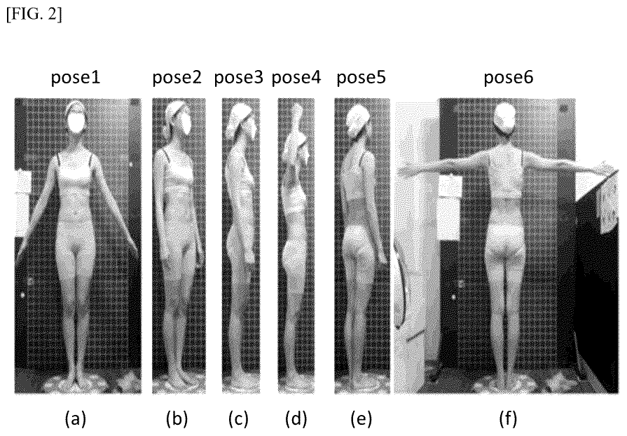

Hereinafter, a method for measuring body measurements using photographic images of the body taken with a mobile device will be described. FIG. 2 is a view illustrating examples of photographing poses provided for a body measurement service according to an embodiment of the present invention which shows six different poses as examples.

Of course, the present invention is not limited to six photographs, and may include three, four, five, seven, or eight photographs.

Referring to FIG. 2, (a) is a frontal body image, (b) is a 45-degree body image rotated 45 degrees to the right from the front, (c) is a 90-degree body image rotated 90 degrees to the right from the front, (d) is a body image in which the arms are raised from the posture shown in (c), (e) is a 135-degree body image rotated 135 degrees to the right from the front, and (f) is a 180-degree body image rotated 180 degrees to the right from the front.

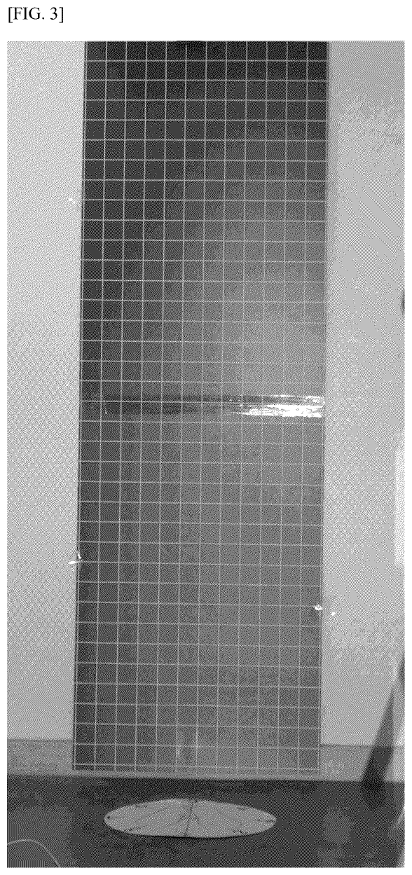

The photographs of FIGS. 2(a) to (f) were taken sequentially while being rotated 45 degrees to the right. FIG. 3 illustrates a scale background board and a foot board, which are size measuring members used during photography. The dimensions (scale intervals) of the scale background board are not particularly limited, and the foot board is also not particularly limited as long as it can indicate the directions to the subject.

The size measuring member is not limited to the scale background board or the foot board described above, and may be any object made of a standard product, such as A4 paper, that can serve as a reference for dimensional measurement.

In addition, the angle of directional change during photographing is not limited to 45°, and FIG. 2 illustrates an example of a foot board fabricated by drawing straight lines radially from the center at 45° intervals, allowing the subject's direction to be changed in 45° increments.

Meanwhile, in each photograph taken at different distances and directions, the body measurements (body angle and length information) of each predetermined body part of the subject are measured. At this time, the body measurement regions in the photograph, where the angles and lengths are measured, correspond to the regions where actual body measurements of the subject were taken (actual measured regions of the subject). Both the photographic body measurement regions and the actual measured regions of the subject may be defined as body regions required for clothing pattern drafting.

To measure the body measurements in the photographs, a known image editing program such as Adobe Photoshop may be used. Assuming that all photographs taken from the same distance have identical scale intervals, the functions provided by the image editing program may be used to determine the length (distance) between two measurement points of each body part and the angle (angle between two straight lines) of each body part.

As described above, when obtaining the dimensions for each body part of the subject (actual measured body measurements) of the subject using a tape measure for length measurement and a protractor for angle measurement, or when obtaining photographic body measurements of each body part, various measurement regions may be predefined. These measurement regions may correspond to body parts for which dimensions are required in clothing pattern drafting, and a large number of measurement regions may be defined to ensure that the resulting clothing pattern accurately fits the body shape. Consequently, up to eight photographs may be acquired for each subject, including front, back, left, and right sides.

Furthermore, during photographing of the subject, the photographing distance may be varied for each subject and direction so that photographs are taken at different distances. For example, to identify image distortion that occurs at short range, photographs may be taken at multiple distances by changing the photographing distance in predetermined increments (for example, 1 m) from a minimum of 3 m to a maximum of 10 m. In addition, for each photograph, photographic measurement information such as the position of the scale background board, the direction on the foot board, the photographing distance, and the photographing angle are recorded.

FIG. 3 is a view illustrating the scale background board and foot board used for photography. The dimensions (scale intervals) of the scale background board are not particularly limited, and the foot board is also not limited as long as it can indicate the directions to the subject. In this embodiment, the angle of directional change during photographing is not limited to 45°, and FIG. 2 illustrates an example of a foot board fabricated by drawing straight lines radially from the center at 45° intervals, allowing the subject's direction to be changed in 45° increments.

Meanwhile, in each photograph taken at different distances and directions, the body measurements (body angle and length information) of each predetermined body part of the subject are measured. At this time, the body measurement regions in the photograph, where the angles and lengths are measured, correspond to the regions where actual body measurements of the subject were taken (actual measured regions of the subject). Both the photographic body measurement regions and the actual measured regions of the subject may be defined as body regions required for clothing pattern drafting.

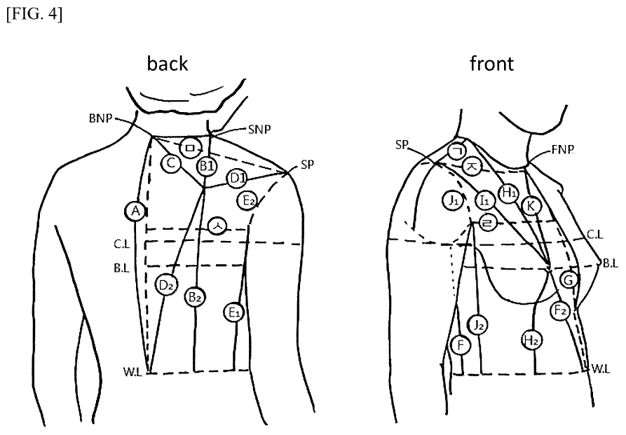

FIG. 4 is a view illustrating actual measured regions of a subject and corresponding measurement regions on a photograph in the present invention. When measuring each body part of the subject to obtain subject's actual measured body measurements, and when measuring each body part of the subject in photographs taken from different directions to obtain photographic body measurements, the measurements may be performed at the same predetermined body regions.

Furthermore, as described below, when photographing a clothing consumer's body to obtain final body measurements from the captured image, the body measurement regions of the consumer in the photograph and the target regions for the final measurements may be defined as the same regions. In this case, all body measurement regions may correspond to the body parts required for clothing pattern drafting.

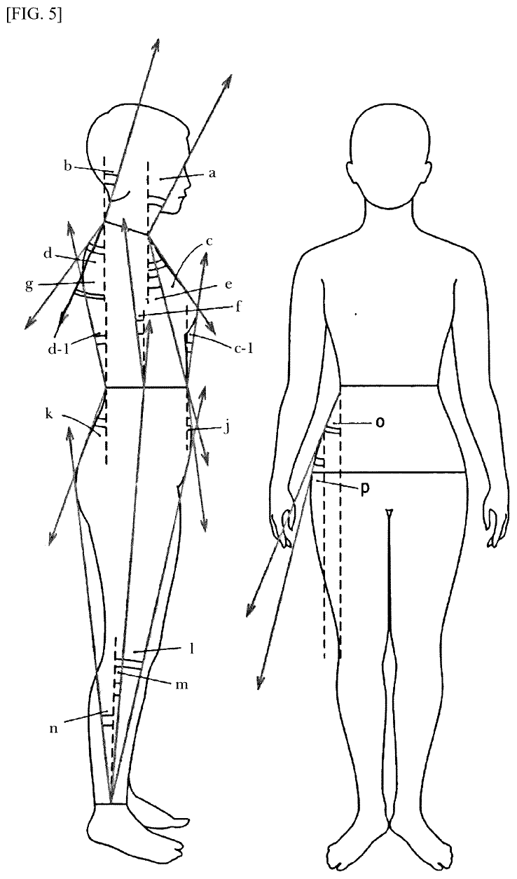

FIG. 5 is a view illustrating angles of respective body parts measured on the actual body of a subject and corresponding angles of respective body parts measured in a photograph in the present invention. When photographing a clothing consumer's body to obtain final body measurements from the captured image, the angles of the consumer's body parts measured in the photograph and the actual angles of the consumer's body parts, which are derived as final measurement values through a calculation formula, may correspond to the angles illustrated in FIG. 5.

Once the body measurements of the subject in the photograph are obtained, a photographing-distance-specific calculation formula capable of determining actual body measurements is derived using both the photographic body measurements of each body part of the subject and the actual measured body measurements of the subject. The derived calculation formula is then programmed, thereby completing a measurement program. Here, the calculation formula is used to calculate the actual body measurements of a clothing consumer, who intends to manufacture or purchase clothing, from the photographic body measurements based on the captured image of the consumer.

Hereinafter, the process of deriving a calculation formula for obtaining actual body measurements from the photographic body measurements will be described in detail. For each photographing distance, statistical analyses such as correlation analysis and regression analysis may be performed using the previously obtained photographic body measurement data for each body part of the subject according to photographing distance and direction, together with the actual measured body measurement data of each subject. Through this process, a calculation formula defining the relationship between the photographic body measurements and the actual measured body measurements is derived for each photographing distance.

For reference, when photographic body measurements are taken for predetermined body parts in each directional photograph of FIG. 2, even the same body part may exhibit different measurements depending on the photographing direction, as shown in FIGS. 2(a) to (f). Therefore, the dimensions for each body part obtained from photographs in each direction are subjected to statistical analysis by distinguishing the photographing directions.

The correlation analysis may be performed to extract photographic body factors that influence the measurements of specific body parts of the subject. In this analysis, the subject's actual measured body measurement data obtained by measuring each body part of the subject and the photographic body measurement data for each body part according to photographing direction are used as variables. The correlation between these two variables is analyzed to identify photographic body measurement items that affect the actual measured body measurements of specific body parts of the subject. Photographic body measurement items exhibiting a high correlation with the actual measured body measurements of each subject are then identified.

Subsequently, based on the results of the correlation analysis, a regression analysis is performed to derive a calculation formula defining the relationship between the actual measured body measurements of each subject and the corresponding photographic body measurement data. The regression analysis uses multiple photographic body measurement items, as independent variables, that have high correlation coefficients with the actual measured body measurements for each body part of the subject as a result of the correlation analysis, thereby obtaining a regression equation for calculating the actual body measurements of each body part of a clothing consumer from the consumer's captured images. These regression equations for each body part are used as calculation formulas for deriving the actual body measurements of the clothing consumer from the consumer's photographic body measurements. Furthermore, even for the same body part, multiple calculation formulas may be derived depending on the photographing distance as calculation formulas for each body part.

In addition, in the calculation formulas for deriving the actual body measurements of each body part of the clothing consumer (which may be individually obtained according to the photographing distance), the variables may include the photographic body measurements of various body parts in the photographs taken from different directions of the clothing consumer.

Here, in each individual calculation formula for deriving the actual measurements of each body part of the clothing consumer, the variables may include the photographic body measurements obtained from the images of the consumer's body parts. In addition to these photographic measurements, the pre-calculated actual measurements of other body parts of the consumer may also be used as additional variables in the calculation formula. That is, once the actual measurement of a certain body part of the clothing consumer has been obtained, this previously obtained actual measurement may be additionally used as a variable so that the actual measurements of other body parts of the consumer are derived through the calculation formulas corresponding to those parts. In this manner, the calculation formulas for deriving the measurements of each body part of the clothing consumer are obtained as regression equations that use, as variables, the photographic body measurements of each body part of the clothing consumer, and optionally, the pre-calculated actual measurements of other body parts of the consumer. The obtained regression equations are then used to calculate the actual body measurements from the photographic body measurements.

Table 1 below illustrates an example of a calculation formula. This example shows a case in which a multiple regression equation obtained through regression analysis is used as the calculation formula, and demonstrates how various body measurement variables obtained from photographs of the clothing consumer may be used to calculate an actual body measurement of the consumer, such as waist circumference.

TABLE 1

| | | | | | | [symbol] | | |
|---|---|---|---|---|---|---|---|---|
| Y | X | | Partial | | | Partial | [symbol] | |
| Dependent | Independent | | Regression | | [symbol] | Correlation | Contribution | Y = β [symbol] X [symbol] + β [symbol] X [symbol] + [symbol] + β [symbol] X [symbol] |
| Variable | Variable | | Coefficient | | Constant | Coefficient | Rate | Multiple Regression Equation |
| Waist | X₁ | [symbol] | β₁ | 30.711 | −11.262 | 0.953 | 90.8% | Y = 30. 711X [symbol] − 16.037X [symbol] 19.912 [symbol] + 1.11 [symbol] X [symbol] + |
| Circumference | | | | | | | | 0.484X [symbol] − 0.605X [symbol] + 1.305X [symbol] − 5.237X [symbol] − |
| | X₂ | [symbol] | β₂ | −16.037 | | | | 0.442X [symbol] − 0.539 [symbol] 4.899 [symbol] − 1.280 [symbol] + 0.1 [symbol] 1 [symbol] + |
| | X₃ | PF-1 | β₃ | 19.912 | | | | 2.807X [symbol] + 1.955X [symbol] − 1. [symbol] 24X [symbol] − 11.262 |
| | X₄ | A | β₄ | 1.117 | | | | |
| | X₅ | B1 | β₅ | 0.484 | | | | |
| | X₆ | B2 | β₆ | −0.605 | | | | |
| | X₇ | D | β₇ | 1.305 | | | | |
| | X₈ | H1 | β₈ | − [symbol] .237 | | | | |
| | X₉ | H2 | β₉ | −0.442 | | | | |
| | X₁₀ | [symbol] | β₁₀ | −0.539 | | | | |
| | X₁₁ | [symbol] | β₁₁ | 4.899 | | | | |
| | X₁₂ | [symbol] | β₁₂ | −1.280 | | | | |
| | X₁₃ | [symbol] | β₁₃ | 0.161 | | | | |
| | X₁₄ | [symbol] | β₁₄ | 2. [symbol] 7 | | | | |
| | X₁₅ | [symbol] | β₁₅ | 1.955 | | | | |
| | X₁₆ | [symbol] | β₁₆ | −1. [symbol] 24 | | | | |

[symbol]

indicates data missing or illegible when filed

While not all variable symbols used in the calculation formulas are shown in the drawings, examples of the variables include B1 and B2, which represent photographic body measurements around the protruding portion of the scapula in photographs of the clothing consumer, as shown in FIG. 4. In this manner, to calculate the actual body measurements of a specific body part of the clothing consumer, photographic measurements of other body parts may be used as variables in the calculation formula.

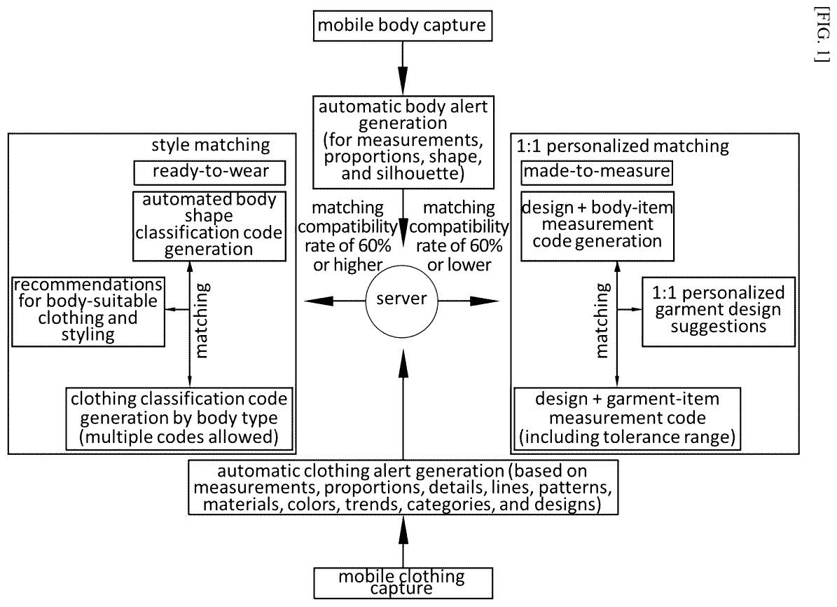

The calculation formula for waist circumference illustrated in Table 1 was derived solely using variables obtained from the frontal photograph of the clothing consumer, as shown in FIG. 1(a). Even in this case, a calculation formula (multiple regression equation) exhibiting a high contribution rate of 90.8% was derived. If additional variables (photographic body measurement items) obtained from photographs taken in multiple directions are further incorporated, a calculation formula with an even higher contribution rate may be derived and utilized.

Once the calculation formulas for each body part used to derive actual body measurements from photographic body measurements are obtained through statistical analysis (for example, multiple regression equations such as those shown in Table 1), these multiple regression equations are programmed to develop the measurement program, which is then stored in a computer. The multiple regression equations used as the calculation formulas in the measurement program are derived through statistical analyses conducted for each photographing distance and are stored as photographing distance-specific regression equations. In actual use, when photographing a clothing consumer, the regression equation corresponding to the photographing distance is selected and applied to calculate the actual body measurements.

After the measurement program is installed on a computer, it may be used to accurately measure a user's body measurements simply by having the user take a photograph using a portable mobile device. Here, the term “user” should be interpreted broadly to refer to any individual requiring accurate body measurements. However, in cases where the final measured body measurements are used for clothing pattern drafting or garment purchasing, the user corresponds to a clothing consumer who intends to manufacture or purchase garments for themselves.

In this manner, the body measurements of the user ultimately obtained according to the present invention may be utilized for various purposes beyond clothing pattern drafting or garment purchasing. Accordingly, as used herein, the term “user” is not limited to a clothing consumer. However, for convenience of description, the following explanation will refer to a clothing consumer as an example.

First, a clothing consumer who requires body measurements take a photograph of themselves in front of a scale background board (see FIG. 3) having identical scale intervals, and the captured photograph is transmitted to a server or computer equipped with the measurement program.

The scale background board may be provided in advance by a clothing seller or manufacturer. The photograph may be taken on-site using a computer equipped with the measurement program, or may alternatively be taken directly by the consumer at home using the scale background board received by mail or obtained by online download and printing.

Furthermore, a foot board (see FIG. 2) as described above may be additionally provided to enable the consumer to take photographs in all predetermined directions (for example, eight directions at 45° intervals). Using the scale background board and the foot board, the consumer can take photographs from various directions. The consumer is required to take the photographs at a predetermined distance, for example, within a range of 3 m to 10 m, and the photographs may be taken using a camera of a smart device (e.g., a smartphone or a tablet PC).

In addition, the height of the camera lens center during photographing may vary depending on the clothing item to be measured. For example, when the clothing item desired by the consumer is a full-body garment, it is preferable to align the camera lens center with the consumer's waist level. For an upper-body garment, it is preferable to align the camera lens center with the consumer's chest level, and for a lower-body garment, with the consumer's hip level.

The photographs taken in this manner are input into the computer equipped with the measurement program and are used to calculate body measurements. When photographing is performed remotely using a smart device, the captured photographs may be directly transmitted from the smart device to the server or computer for input through an online transmission method.

Once the photographs of the consumer are obtained, adjustment of the image size may be required. A preprocessing step may be performed using the scale intervals shown in the photograph to enlarge or reduce the image so that it corresponds to the standard scale. That is, since consumers may take photographs in various sizes, the captured images may have a non-standard size. Accordingly, the size of the captured image is adjusted so that the scale intervals shown in the photograph corresponds to the predetermined standard size, thereby obtaining an image suitable for accurate body measurement.

Such image size adjustment may be performed using a separate image editing program, which may also be used to obtain the dimensions (angles and lengths) of each body part shown in the photograph. At this time, the body parts whose angles and lengths are measured in the photograph correspond to those shown in FIG. 4, that is, the same body parts that were measured earlier to derive the calculation formulas.

Ultimately, when the photographic body measurements are input as variables into the measurement program, the regression equations stored in the program calculate the actual measurements of each body part of the consumer.

1. A smart fashion coordination service method performed using an application installed on a mobile terminal, the method comprising:
photographing, by the mobile terminal, a body of a user with a camera of the mobile terminal to capture a body image;
transmitting, by the mobile terminal, the captured body image to a server;
measuring, by the server, the user's body measurements from the received body image to obtain body measurement information;
photographing, by the mobile terminal, clothing owned by the user with the camera of the mobile terminal to capture a clothing image;
transmitting, by the mobile terminal, the captured clothing image to the server;
measuring, by the server, the clothing measurements and body proportions from the received clothing image to obtain clothing measurement information and body proportion information;
determining, by the server, whether coordination is appropriate or inappropriate based on preset criteria by matching the user's body measurement information with the clothing measurement information and body proportion information;
providing, by the server, ready-made garment product information included in a product line composed of multiple ready-made garments to the mobile terminal of the user for whom the coordination is determined to be appropriate; and
providing, by the server, custom-made clothing product information corresponding to the user's body measurement information to the mobile terminal of the user for whom the coordination is determined to be inappropriate.

2. The method according to claim 1, wherein the step of photographing, by the mobile terminal, a body of a user with a camera of the mobile terminal to capture a body image, and the step of photographing, by the mobile terminal, clothing owned by the user with the camera of the mobile terminal to capture a clothing image are performed together with a size measuring member disposed adjacent to the user's body and/or the clothing, the size measuring member being made of a standard product.

3. The method according to claim 2, wherein the size measuring member is A4 paper.

4. The method according to claim 2, wherein the size measuring member is a scale background board having scales arranged at regular intervals and extending in at least one direction.

5. The method according to claim 1, further comprising:
inputting, into the mobile terminal, matching condition information such as the user's taste, preferred style, and coordination suitable for a given time, place, and occasion (TPO); and
transmitting, by the mobile terminal, the matching condition information to the server,
wherein, in the step of providing, by the server, ready-made garment product information included in a product line composed of multiple ready-made garments to the mobile terminal of the user for whom the coordination is determined to be appropriate, and in the step of providing, by the server, custom-made clothing product information corresponding to the user's body measurement information to the mobile terminal of the user for whom the coordination is determined to be inappropriate,
ready-made garment product information or custom-made clothing product information filtered based on the matching condition information received from the mobile terminal is provided.

6. The method according to claim 1, wherein the step of photographing, by the mobile terminal, a body of a user with a camera of the mobile terminal to capture a body image comprises obtaining multiple body images taken from two or more different photographing distances and/or photographing angles.

7. The method according to claim 1, further comprising adjusting, by the server, sizes of the received body images and/or clothing images based on a captured image size of a size measuring member included in the received body images and/or clothing images.

8. The method according to claim 1, wherein the step of measuring, by the server, the clothing measurements and body proportions from the received clothing image to obtain clothing measurement information and body proportion information comprises acquiring clothing measurement information and body proportion information from the location, size, or number of one or more of the following groups included in the received clothing image: cut lines (horizontal and vertical), buttons, pockets, straps, epaulets, tapes, lace decorations, and belt loops.

9. The method according to claim 1, further comprising matching pre-captured dimensional information of a subject obtained through photographing with actual measured dimensional information, and performing regression analysis on correlations therebetween to derive and pre-store a calculation formula for determining body measurement information,
wherein the step of measuring, by the server, the user's body measurements from the received body image to obtain body measurement information comprises obtaining the body measurement information using the calculation formula pre-stored in the server.

10. The method according to claim 1, wherein the server pre-sets and stores a body type classification code for classifying measured body measurement information according to preset criteria, and generates a body type classification code for the user by substituting ratios of the user's measured body dimensions as variables into the preset classification criteria.

11. The method according to claim 1, wherein the server pre-sets and stores a suitable body type code for classifying extracted clothing measurement information and body proportion information according to preset criteria, and generates a suitable body type code for the corresponding clothing by substituting extracted clothing measurement information and body proportion information as variables into the preset classification criteria.
